(19) United States
(12) Patent Application Publication
(10) Pub. No.: US 2025/0292096 A1
(43) Pub. Date: Sep. 18, 2025

(54) MULTI-DIMENSIONAL PARTNERSHIP OPTIMIZATION AND STRATEGIC RELATIONSHIP ALIGNMENT

(71) Applicant: INTERNATIONAL BUSINESS MACHINES CORPORATION, ARMONK, NY (US)

(72) Inventors: Jessica Nahulan, Markham (CA); Fang Lu, Billerica, MA (US); Martin G. Keen, Cary, NC (US); Jeremy R. Fox, Georgetown, TX (US)

(21) Appl. No.: 18/603,381

(22) Filed: Mar. 13, 2024

(51) Int. Cl. G06N 3/09; G06N 3/042

(52) U.S. Cl. CPC G06N 3/09; G06N 3/042

(57) ABSTRACT

An approach is provided for partnership optimization. Using a supervised machine learning model, a categorized profile of partners is generated based on feedback from clients and past performances of the partners. The categorized profile indicates strengths of the partners. A network graph is generated based on data about interactions between the partners and clients and the categorized profile. The network graph has nodes representing the partners and the clients and edges representing connections between the partners and the clients. Using the categorized profile and the network graph, a three-dimensional model is generated and represented by a three-dimensional matrix of cells. A given cell represents a part of a project and includes constraint(s) of the project. Using a machine learning algorithm based on Thistlethwaite's algorithm, the model is solved to optimally match the constraint(s) with strength(s) of partner(s) and strength(s) of connection(s) between the partner(s) and client(s).

### BACKGROUND

The present invention relates to partnership optimization, and more particularly to creating and using a machine learning-based multi-dimensional model for partnership management and strategic decision-making.

### SUMMARY

In one embodiment, the present invention provides a computer-implemented method. The method includes generating, using a supervised machine learning model, a categorized profile of partners based on feedback from clients and past performances of the partners. The categorized profile indicates strengths of the partners. The method further includes generating a network graph based on data about interactions between the partners and the clients and further based on the categorized profile of the partners. The network graph has nodes representing the partners and the clients and has edges representing connections between the partners and the clients. The method further includes generating, using the categorized profile and the network graph, a three-dimensional model represented by a three-dimensional matrix of cells. A given cell represents a part of a project and includes one or more constraints of the project. The method further includes solving, by a processor set and using a machine learning algorithm based on Thistlethwaite's algorithm, the three-dimensional model to optimally match the one or more constraints with one or more strengths of respective one or more partners and one or more strengths of one or more connections between the respective one or more partners and respective one or more clients.

A computer system and a computer program product corresponding to the above-summarized computer-implemented method are also described herein.

### BRIEF DESCRIPTION OF THE DRAWINGS

FIG. 1 is a block diagram of a system for partnership optimization, in accordance with embodiments of the present invention.

FIG. 2 is a block diagram of modules included in code included in the system of FIG. 1, in accordance with embodiments of the present invention.

FIG. 3 is a flowchart of a process of partnership optimization, where operations of the flowchart are performed by modules in FIG. 2, in accordance with embodiments of the present invention.

FIG. 4 is a block diagram of components that perform the operations in the flowchart of FIG. 3, in accordance with embodiments of the present invention.

FIG. 5 is a flowchart of process steps performed by a partner strength profiler, which is included in the components of FIG. 4, in accordance with embodiments of the present invention.

FIG. 6 is a flowchart of process steps performed by a client-partner relationship indexer, which is included in the components of FIG. 4, in accordance with embodiments of the present invention.

FIG. 7 is a flowchart of process steps performed by a constraint solver, which is included in the components of FIG. 4, in accordance with embodiments of the present invention.

### DETAILED DESCRIPTION

### Overview

Corporations often are required to work with a diverse array of business partners, each having unique strengths in various sectors. Business partners are also referred to herein simply as “partners.” The complexity of these partnerships becomes a concern in conventional partnership management, especially in terms of revenue sharing and capacity profiling. Partners specialize in fields ranging from hardware solutions, mainframe command, data science, artificial intelligence, and many others. Conventional partnership management approaches fail to overcome challenges in objectively assessing and harnessing these distinct strengths when engaging various client opportunities. Similarly, the issue of managing variable relationship dynamics arises in conventional approaches. Some business partners may maintain strong relationships with certain clientele, but not with others. This differentiation poses a challenge, causing further complexity in conventional partnership management. Conventional approaches of partnership and relationship management are incomplete and inflexible. These problems extend beyond the software industry, including but not limited to technology, commerce, online e-commerce, and supply chain management.

Embodiments of the present invention address the aforementioned unique challenges by creating a machine learning-based multi-dimensional model in a partnership optimization system, where the multi-dimensional model has aspects similar to a Rubik's Cube® puzzle, and where the model computes various strengths and relationship dynamics of business partners for strategic decision-making. Rubik's Cube is a registered trademark of Spin Master Toys UK Limited, located in Buckinghamshire, United Kingdom. Embodiments of the present invention provide a holistic and adaptable partnership management technique that considers project management's triple constraint of scope, cost, and time, together with an alignment between sales opportunities and business partners, thereby providing effective strategies for business expansion and profitability. Embodiments of the present invention effectively manage the various strengths of different partners in cases in which multi-dimensional relationships exist among partners, clients, and accounts, thereby enhancing sales opportunities and partnership efficacy.

In one embodiment, a strategic optimization system is disclosed herein that uses data science and machine learning, while employing a multi-dimensional model reminiscent of a Rubik's Cube® puzzle for ease of visualization and understanding. The optimization system disclosed herein utilizes partner strengths and client-partner relationship strengths as the basis for strategic decision-making, such as decision-making for sales opportunities and profitability. The multi-dimensional model is continuously evolving as machine learning techniques provide learning from newly incorporated project data, which keeps the optimization system up-to-date and relevant.

Input to the strategic optimization system disclosed herein include (i) data about various partners and their areas of strength; (ii) data about past and current interactions between partners and clients; (iii) key project constraints such as time, cost, and scope; and (iv) feedback and results from past project performances.

Output from the strategic optimization system includes (i) a categorized profile of partners indicating the distinct strengths and areas of expertise of the partners; (ii) a client-partner relationship index that provides a quantified view of the interaction between partners and clients; (iii) an optimized solution matching the most suitable partner strengths to project constraints; and (iv) a continuously evolving learning model that takes account of changing project data.

The strategic optimization system disclosed herein provides an optimized partner match, thereby allowing a strategic formation of business teams for specific projects, which lead to optimal outcomes, including improvement in overall project execution and customer satisfaction rate. The optimization system provides an enhanced understanding of client-partner relationships, which can guide decisions about resource allocation, thereby improving efficiency and lowering the likelihood of wasting resources. Furthermore, the optimization system disclosed herein has an ability to update and evolve as new project data is incorporated, which provides insights about future project demands and potential success with partners and clients.

### Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, computer-readable storage media (also called “mediums”) collectively included in a set of one, or more, storage devices, and that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

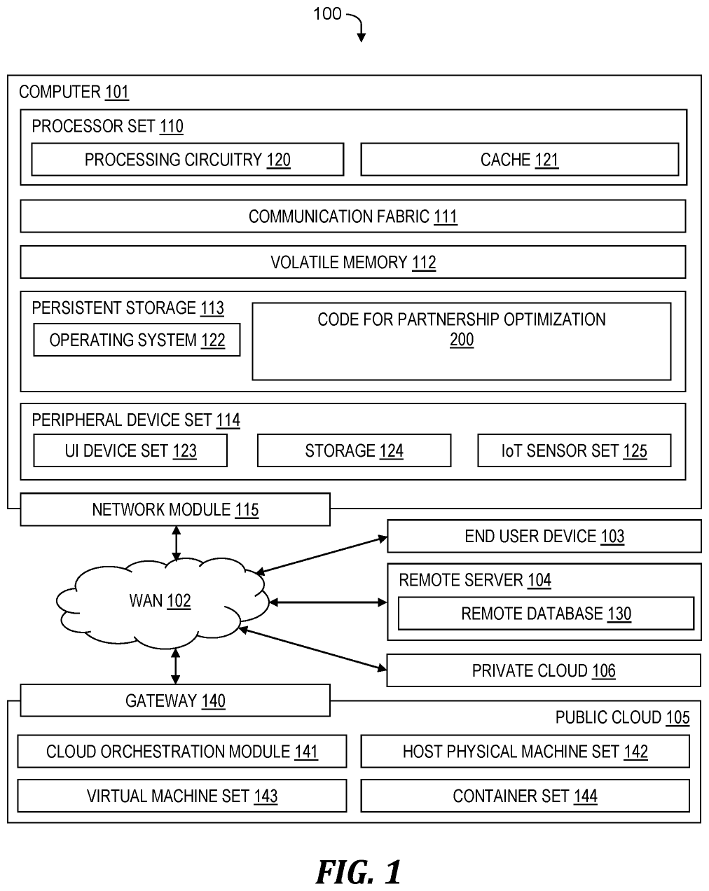

FIG. 1 is a block diagram of a system for partnership optimization, the system being a computing environment 100, in accordance with embodiments of the present invention.

Computing environment 100 contains an example of an environment for the execution of at least some of the computer code involved in performing the inventive methods, such as code 200 for partnership optimization. The aforementioned computer code is also referred to herein as computer-readable code, computer-readable program code, and machine readable code. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

### System and Process for Partnership Optimization

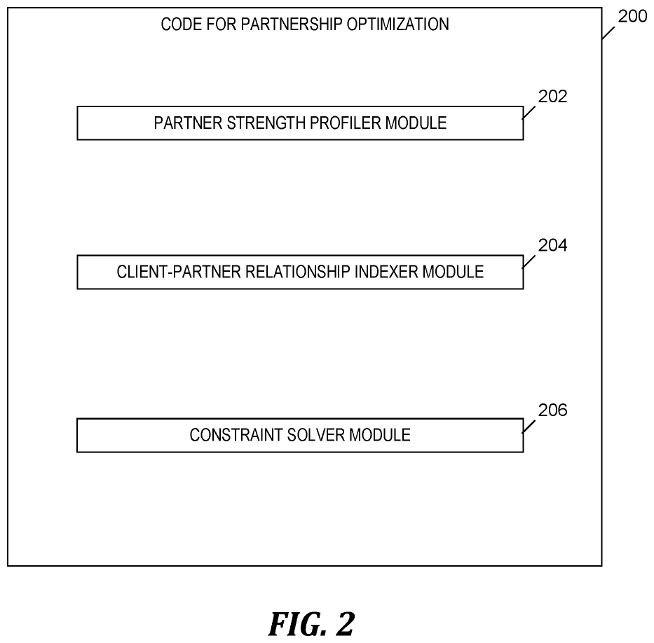

FIG. 2 is a block diagram of modules included in code 200 included in the system of FIG. 1, in accordance with embodiments of the present invention. Code 200 includes a partner strength profiler module 202, a client-partner relationship indexer module 204, and a constraint solver module 206.

Partner strength profiler module 202 is configured to collect, clean, normalize, and categorize data about capabilities and strengths of various business partners. Partner strength profiler module 202 is further configured to use one or more supervised learning models and principal component analysis (PCA) to select and extract relevant features. Partner strength profiler module 202 is further configured to train the supervised learning models and validate the models via cross-validation. Partner strength profiler module 202 is further configured to continuously update and refine the categories of the aforementioned categorized data to reflect changes in the capabilities and strengths and maintain accuracy in the categorization of the partners.

Client-partner relationship indexer module 204 is configured to establish and measure the strength of interactions between partners and clients through the collection and cleaning of data about interactions between partners and clients and through construction of network graphs. Client-partner relationship indexer module 204 is further configured to construct a client-partner relationship index that estimates the strength of client-partner relationships by using centrality measures and feature weights, which are assigned based on past interactions between the partners and the clients, strengths of the partners, and trustworthiness (i.e., measures of levels of trust) of the partners and clients. Client-partner relationship indexer module 204 is further configured to continuously update the client-partner relationship index based on data about new interactions between partners and clients, thereby maintaining the relevancy of the client-partner relationship index. A strength of an interaction between a client and a partner is also referred to herein as a strength of a client-partner relationship or a strength of a connection between a client and a partner.

Constraint solver module 206 is configured to combine multi-dimensional constraints of projects with the strengths of the partners and the strengths of the client-partner relationships. Constraint solver module 206 is further configured to initialize a three-dimensional (3D) matrix, which has aspects analogous to a Rubik's Cube® puzzle, where each cell of the 3D matrix represents part(s) of a project associated with equipped partners and clients. Constraint solver module 206 is further configured to solve the 3D matrix using a machine learning algorithm, which is a variation of Thistlethwaite's algorithm, to find an optimal solution that offers an optimal combination of partner strengths and client-partner relationships. The optimal combination can be, for example, a combination of partner strengths and client-partner relationships overlaying constraints of a project, so that sales opportunities are maximized. Constraint solver module 206 is further configured to recalibrate the 3D matrix to account for changes in project constraints and/or new projects, thereby ensuring dynamic solution optimization.

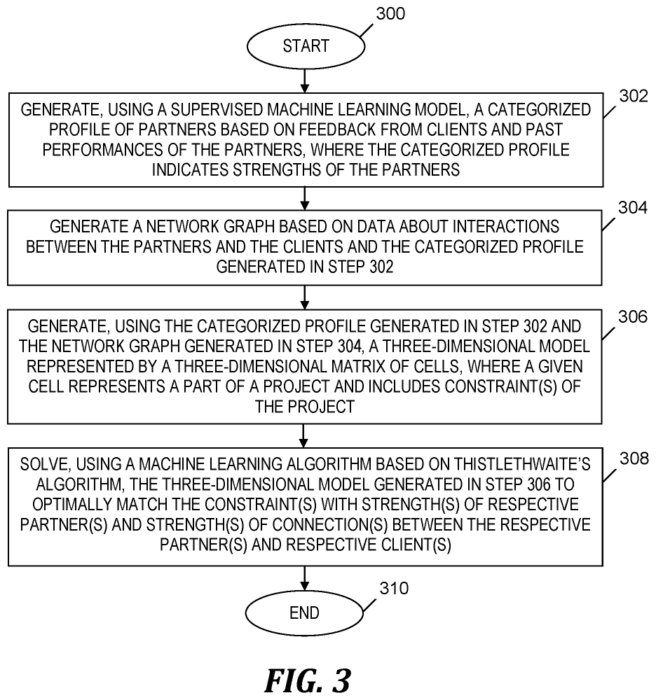

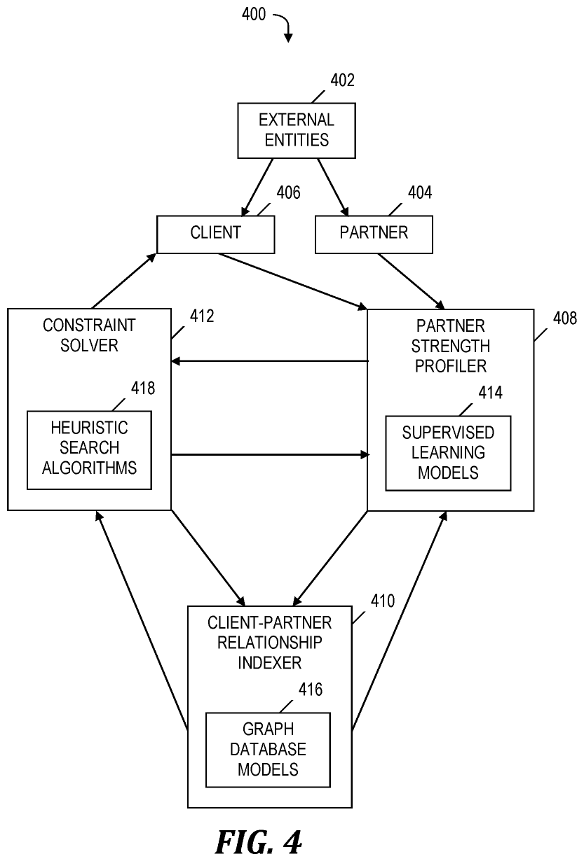

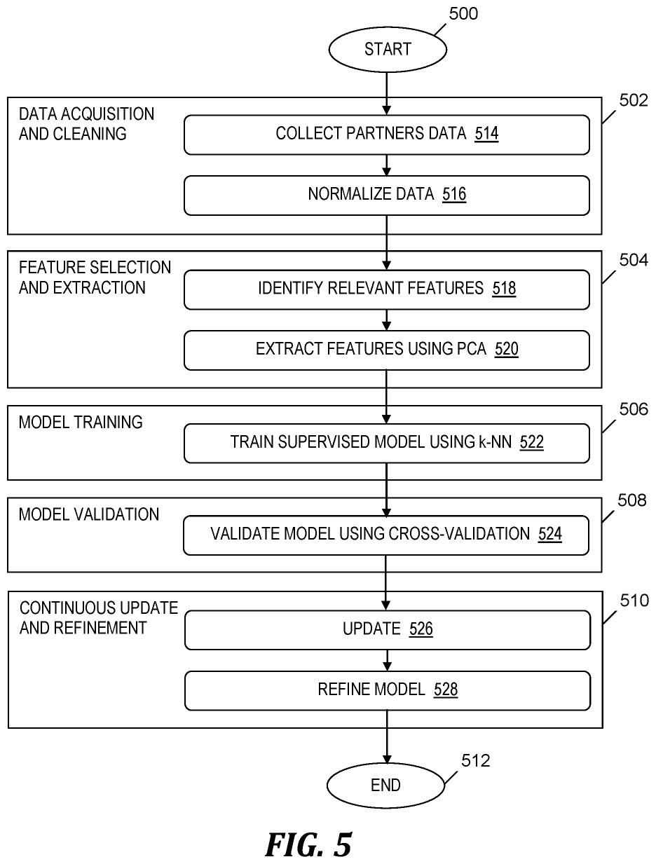

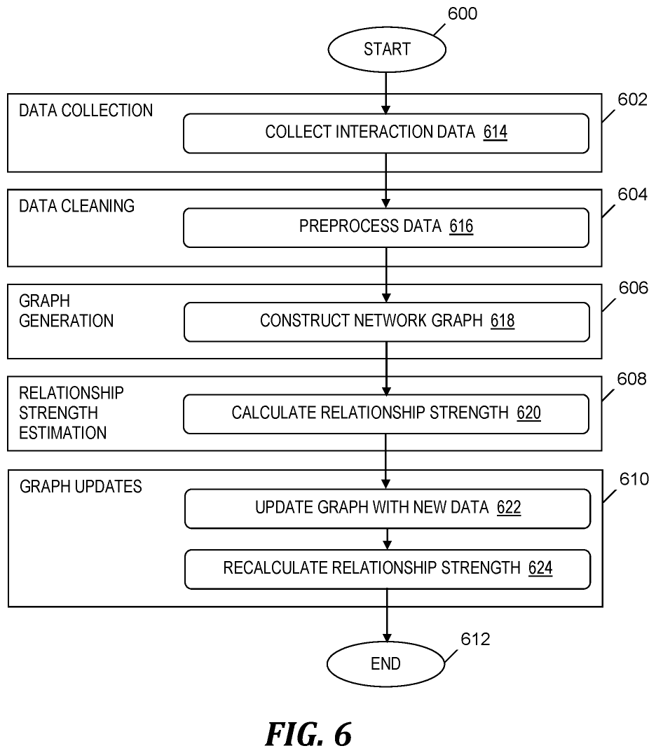

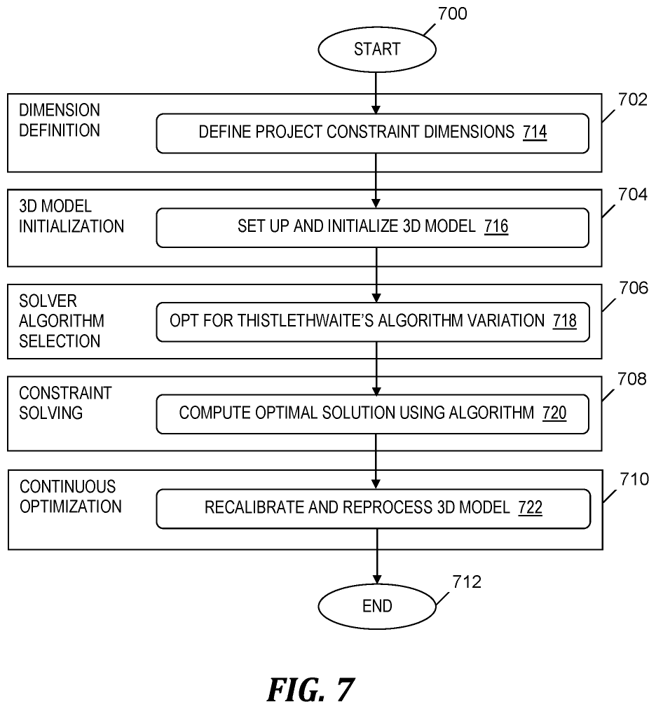

The functionality of the modules included in code 200 is described in more detail in the discussions presented below relative to FIG. 3, FIG. 4, FIG. 5, FIG. 6, and FIG. 7.

FIG. 3 is a flowchart of a process of partnership optimization, where operations of the flowchart are performed by modules in FIG. 2, in accordance with embodiments of the present invention. The process of FIG. 3 begins at a start node 300. In step 302, partner strength profiler module 202 generates, using supervised machine learning model(s), a categorized profile of partners based on feedback from clients and data about past performances of the partners. The categorized profile of the partners includes strengths of the partners. As used herein, a strength of a partner is a measure of a capability of a partner in an area of expertise.

In step 304, client-partner relationship indexer module 204 generates a network graph based on data about interactions between the partners and the clients, and further based on the categorized profile of the partners generated in step 302.

In step 306, constraint solver module 206 generates, using the categorized profile generated in step 302 and the network graph generated in step 304, a three-dimensional model represented by a three-dimensional matrix of cells. A given cell in the three-dimensional matrix of cells represents a part of a project and includes constraint(s) of the project.

In step 308, constraint solver module 206 solves, using a machine learning algorithm that is a variation of Thistlethwaite's algorithm, the three-dimensional model generated in step 306 to optimally match the constraint(s) with strength(s) of respective partner(s) and strength(s) of connection(s) between the respective partner(s) and respective client(s).

Following step 308, the process of FIG. 3 ends at an end node 310.

In one embodiment, the solving in step 308 includes selecting a database or a software framework to generate a technical product. In another embodiment, the solving in step 308 includes assessing a software selection or a hardware selection for generating a technical product.

FIG. 4 is a block diagram of components in a system 400, where the components perform the operations in the flowchart of FIG. 3, in accordance with embodiments of the present invention. System 400 includes external entities 402, a partner 404, a client 406, a partner strength profiler 408, a client-partner relationship indexer 410, and a constraint solver 412. Partner strength profiler 408 includes a supervised learning model 414. Client-partner relationship indexer 410 includes a graph database model 416. Constraint solver 412 includes a heuristic search algorithm 418. In one embodiment, partner strength profiler 408 includes partner strength profiler module 202, client-partner relationship indexer 410 includes client-partner relationship indexer module 204, and constraint solver 412 includes constraint solver module 206.

External entities 402 coordinates with partner 404 and provides a client requirement to client 406. Partner 404 inputs partner strengths to partner strength profiler 408. Client 406 inputs the client requirement to partner strength profiler 408.

Partner strength profiler 408 utilizes supervised learning models 414 to identify and categorize partners based on strengths of the partners, such as hardware, mainframe, artificial intelligence (AI), and data science. Partner strength profiler 408 transfers categorized data about partner strengths to client-partner relationship indexer 410, which is used to define client-partner relationships. Partner strength profiler 408 sends new data about partner strength categorization to constraint solver 412, which is used as a basis for the formation of optimal project scenarios that consider partner strengths and client-partner relationships.

Client-partner relationship indexer 410 uses graph database models 416 to construct a complex network graph to include weighted links between nodes representing clients and partners. The weighted links are based on multiple factors, including past collaboration experiences between the clients and partners, measures of levels of trust in clients and partners, successes associated with the past collaborations between the clients and partners, etc. Client-partner relationship indexer 410 sends data about client-partner relationships to partner strength profiler 408 to refine the partner strength categorization. Client-partner relationship indexer 410 sends data about historical client-partner relationship context to constraint solver 412 to be used as a basis for the optimization process performed by constraint solver 412.

Constraint solver 412 employs heuristic search techniques provided by heuristic search algorithms 418. In one embodiment, the aforementioned heuristic search techniques are tailored to the classic Project Management Triple Constraint Model. The heuristic search techniques identify an optimal balance between time, cost, and scope of a project. Constraint solver 412 sends historical data about optimized solutions to partner strength profiler 408 to update partner classifications, and to client-partner relationship indexer 410 to update representations of the client-partner relationships in the network graph. Constraint solver 412 receives new data about partner strength categorization from partner strength profiler 408 and new data about client-partner relationships from client-partner relationship indexer 410 to be used as a basis for subsequent optimization processes. Constraint solver 412 outputs optimized scenarios to client 406.

FIG. 5 is a flowchart of process steps performed by partner strength profiler 408, which is included in the components of FIG. 4, in accordance with embodiments of the present invention. The process of FIG. 5 begins at a start node 500 and is followed by data acquisition and cleaning in step 502, feature selection and extraction in step 504, model training in step 506, model validation in step 508, and continuous update and refinement in step 510. Following step 510, the process of FIG. 5 ends at an end node 512.

In sub-step 514, which is included in step 502, partner strength profiler 408 collects comprehensive data about the partners. In one embodiment, the comprehensive data includes areas of expertise of the partners (e.g., hardware, mainframe, AI, and data science), past performances of the partners, and client feedback. In sub-step 516, which his included in step 502, partner strength profiler 408 cleans and normalizes the data collected in sup-step 514 to ensure data consistency and accuracy, which is important because the quality of input data significantly impacts the effectiveness of the supervised learning models 414 (i.e., the machine learning models).

In sub-step 518, which is included in step 504, partner strength profiler 408 identifies features (i.e., factors) that are relevant to a partner's strengths. In one embodiment, the features include knowledge areas of a partner, experience levels of the partner, and historical data about relationship(s) between the partner and client(s). In sub-step 520, which is included in step 504, partner strength profiler 408 extracts the identified features using PCA to shorten the list of variables.

In sub-step 522, which is included in step 506, partner strength profiler 408 uses the features extracted in sub-step 520 to train a machine learning model by using a supervised k-Nearest Neighbors (k-NN) algorithm.

In sub-step 524, which is included in step 508, partner strength profiler 408 validates the trained machine learning model by using a separate data set to ensure robust and reliable predictions. In one embodiment, the validation of the machine learning model in sub-step 524 uses cross-validation to mitigate overfitting and underfitting of training data.

In sub-step 526, which is included in step 510, partner strength profiler 408 continuously updates the machine learning model to take into account changes and maintain accuracy in partner strength categorization. In sub-step 528, which is included in step 510, partner strength profiler 408 refines the machine learning model as the database grows and transforms.

In the process of FIG. 5, partner strength profiler 408 can use, for example, Scikit-Learn® software for categorization, a Pandas software library for data manipulation, and NoSQL databases for data handling. Scikit-learn is a registered trademark of Institute National de Recherche en Informatique et en Automatique located in Le Chesnay, France.

FIG. 6 is a flowchart of process steps performed by client-partner relationship indexer 410, which is included in the components of FIG. 4, in accordance with embodiments of the present invention. The process of FIG. 6 begins at a start node 600 and is followed by data collection in step 602, data cleaning in step 604, graph generation in step 606, relationship strength estimation in step 608, and graph updates in step 610. Following step 610, the process of FIG. 6 ends at an end node 612.

In sub-step 614, which is included in step 602, client-partner relationship indexer 410 collects data about interactions between partners and clients. In one embodiment, the data collected in sub-step 614 includes the frequency of interactions between the partners and the clients, rates of success in the interactions between the partners and the clients, scores from clients indicating feedback about the partners, and other relevant metrics for measuring the strength of relationships between partners and clients.

In sub-step 616, which is included in step 604, client-partner relationship indexer 410 cleans and preprocesses the data collected in sub-step 614, which includes removing outliers, handling missing values, and validating the relationship metrics to ensure an accurate representation of the interactions between partners and clients.

In sub-step 618, which is included in step 606, client-partner relationship indexer 410 constructs a network graph based on the data cleaned and preprocessed in sub-step 604. The network graph constructed in sub-step 606 includes nodes representing partners, nodes representing clients, and weighted edges between nodes representing the strength of connections between partners and clients.

In sub-step 620, which is included in step 608, client-partner relationship indexer 410 calculates estimations of the strength of each relationship in the network graph by using graph theory measures, including edge weight and centrality measures. The calculation of estimations of the strength of the relationships in sub-step 620 results in the generation of the client-partner relationship index.

In sub-step 622, which is included in step 610, client-partner relationship indexer 410 continuously updates the network graph with new data about existing interactions between partners and clients and data about new client-partner interactions. In sub-step 624, which is included in step 610, client-partner relationship indexer 410 recalculates the estimations of the strength of each relationship in the network graph to maintain the relevancy of the client-partner relationship index.

In the process of FIG. 6, client-partner relationship indexer 410 can use, for example, graph database models 416 for network graph generation and interaction mapping, a NetworkX software library for graph theory and structure, a Pandas software library for data manipulation, and a Neo4j® graph database management system for data handling. Neo4j is a registered trademark of Neo4j, Inc. located in San Mateo, California.

FIG. 7 is a flowchart of process steps performed by constraint solver 412, which is included in the components of FIG. 4, in accordance with embodiments of the present invention. The process of FIG. 7 begins at a start node 700 and is followed by dimension definition in step 702, 3D model initialization in step 704, solver algorithm selection in step 706, constraint solving in step 708, and continuous optimization in step 710. Following step 710, the process of FIG. 7 ends at an end node 712.

In sub-step 714, which is included in step 702, constraint solver 412 defines dimensions that represent the constraints of the project, where the constraints include time, cost and scope. To define the dimensions in sub-step 714, constraint solver 412 uses data about partner strength from partner strength profiler 408 and data about client-partner relationships.

In sub-step 716, which is included in step 704, constraint solver 412 sets up and initializes the 3D model represented by a 3D matrix. Each cell in the 3D matrix represents part of a project, attributed with constraints and linked to specific partners and clients.

In sub-step 718, which is included in step 706, constraint solver 412 selects a variation of Thistlethwaite's algorithm, which is a method for solving a Rubik's Cube® puzzle. The variation of Thistlethwaite's algorithm is an adjustment of Thistlethwaite's algorithm to conform to the constraints of the project, which is different from the color alignment constraint of a Rubik's Cube® puzzle.

In sub-step 720, which is included in step 708, constraint solver 412 processes the 3D model to compute an optimal solution of the 3D matrix using the variation of Thistlethwaite's algorithm selected in sub-step 718. The output of sub-step 720 is the most suitable partner-client alignment under the constraints of the project.

In sub-step 722, which is included in step 710, constraint solver 412 continuously recalibrates and reprocesses the 3D model as new projects and/or alterations in existing project constraints occur, thereby ensuring dynamic optimization.

In the process of FIG. 7, constraint solver 412 can use, for example, a variation of Thistlethwaite's algorithm for manipulating the 3D model and resolving the constraints, a NumPy® software library for multidimensional array handling, a TensorFlow® software library for implementing the machine learning algorithm, and a Pandas software library for data manipulation. NumPy is a registered trademark of NumFOCUS, Inc. located in Dallas, Texas. TensorFlow is a registered trademark of Google LLC located in Mountain View, California.

### Thistlethwaite'S Algorithm

Thistlethwaite's algorithm is a well-regarded approach for solving a Rubik's Cube® puzzle. First proposed by Morwen B. Thistlethwaite in the 1980s, the algorithm operates by systematically reducing the number of possible cube states in separate stages until arriving at a solved state. This strategy recognizes the Rubik's Cube® puzzle as a member of the G-group (i.e., a set of all possible cube states) and utilizes four different subgroups (i.e., G1, G2, G3, and G4), each progressively closer to the solved cube state, represented by the identity element H.

An overview of Thistlethwaite's algorithm is described below in four stages:

1. G0→G1: Use any of the cube's standard 18 moves (i.e., any quarter-turn) to orient all edges correctly.

2. G1→G2: From this point, disallow any 90 degree turns of the front and back faces. The aim is to reach a state where every edge and corner piece is in its correct “slice.”

3. G2→G3: Further restrict the allowed moves by permitting only half-turns of the front and back faces. This stage aims to correctly position all edge pieces.

4. G3→G4: From this point, only half-turn moves are allowed on any face. The final goal is to correct the corners' orientation and complete the cube (i.e., reach G4, where G4 is H).

### EXAMPLES

In one example, M is a Partner Relations Manager at a multinational technology firm. M struggles with balancing the disparate strengths possessed by partners used by M and coordinating those strengths with varying needs of clients. Using the optimization system disclosed herein, M can visualize the differing strengths each partner possesses, layer that visualization of strengths over client-partner relationships, and optimize the combination of partner strengths and client-partner relationships for revenue sharing. The aforementioned utilization of the optimization system allows for more informed, strategic planning associated with utilizing different partners.

In another example, a medium-scale information technology provider has strengths in data science and robust relationships with several clients, but struggles with hardware or mainframe capabilities and has weaker relationships with other clients. Using the optimization system disclosed herein, the unique strengths and weaknesses of the provider are assessed. The optimization system aligns strengths with certain client engagements, thereby helping the provider identify where the provider can maximize opportunities based on their data science acumen, while accepting assistance from partners to address the provider's lack of hardware expertise.

The descriptions of the various embodiments of the present invention have been presented herein for purposes of illustration but are not intended to be exhaustive or limited to the embodiments disclosed. Many modifications and variations will be apparent to those or ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
generating, using a supervised machine learning model, a categorized profile of partners based on feedback from clients and past performances of the partners, the categorized profile indicating strengths of the partners;
generating a network graph based on data about interactions between the partners and the clients and further based on the categorized profile of the partners, the network graph having nodes representing the partners and the clients and having edges representing connections between the partners and the clients;
generating, using the categorized profile and the network graph, a three-dimensional model represented by a three-dimensional matrix of cells, a given cell representing a part of a project and including one or more constraints of the project; and
solving, by a processor set and using a machine learning algorithm based on Thistlethwaite's algorithm, the three-dimensional model to optimally match the one or more constraints with one or more strengths of respective one or more partners and one or more strengths of one or more connections between the respective one or more partners and respective one or more clients.

2. The method of claim 1, wherein the generating the categorized profile includes:
collecting, cleaning, and normalizing data about the partners by using principal component analysis and the supervised learning model to select features, the cleaning and the normalizing providing a consistency and an accuracy in the collected data, and the collected data including areas of expertise of the partners, past performances of the partners, and client feedback about the partners;
identifying, by the supervised learning model, features in the collected, cleaned, and normalized data having a relevancy to the strengths of the partners, the features including knowledge areas of the partners, experience levels of the partners, and a history of relationships involving the partners;
extracting the features by using principal component analysis (PCA);
training the supervised learning model by using the identified and extracted features and a k-Nearest Neighbors algorithm; and
validating the trained supervised learning model by using a separate data set to ensure a reliability in predictions by the supervised learning model.

3. The method of claim 2, further comprising continuously updating and refining the collected data and the supervised learning model based on new data about the areas of expertise, the past performances, and the client feedback to maintain an accuracy in a categorization of the partners based on the strengths of the partners.

4. The method of claim 1, further comprising:
collecting data about the interactions between the partners and the clients, the collected data including a frequency of the interactions, rates of success resulting from the interactions, and scores indicating feedback from the clients and the partners about the interactions;
cleaning the collected data to remove outliers, manage missing values, and validate relationship metrics included in the collected data, wherein the generating the network graph is based on the cleaned data;
estimating, using a graph database model, strengths of the connections between the partners and the clients by measuring weights of the edges in the network graph and using centrality measures, the weights being based on past interactions between the partners and the clients, the strengths of the partners, and measures of trustworthiness of the partners and the clients; and
generating, using the graph database model, a client-partner relationship index based on the estimated strengths of the connections between the partners and the clients.

5. The method of claim 4, further comprising continuously updating the client-partner relationship index and the network graph by using data about new interactions between the partners and the clients to re-estimate the strengths of the connections between the partners and the clients.

6. The method of claim 1, wherein the generating the three-dimensional matrix of cells includes:
defining constraints of the project by using the categorized profile of the partners and the network graph, the constraints including a time, a cost, and a scope of the project;
initializing the three-dimensional model as the three-dimensional matrix; and
selecting a variation of Thistlethwaite's algorithm based on the defined constraints, wherein the solving the three-dimensional model uses the selected variation of Thistlethwaite's algorithm.

7. The method of claim 1, further comprising continuously updating the three-dimensional matrix based on data about new projects and alterations in constraints of existing projects.

8. A computer system comprising:
a processor set;
a set of one or more computer-readable storage media; and
program instructions, collectively stored in the set of one or more computer-readable storage media, for causing the processor set to perform the following computer operations:
generate, using a supervised machine learning model, a categorized profile of partners based on feedback from clients and past performances of the partners, the categorized profile indicating strengths of the partners;
generate a network graph based on data about interactions between the partners and the clients and further based on the categorized profile of the partners, the network graph having nodes representing the partners and the clients and having edges representing connections between the partners and the clients;
generate, using the categorized profile and the network graph, a three-dimensional model represented by a three-dimensional matrix of cells, a given cell representing a part of a project and including one or more constraints of the project; and
solve, using a machine learning algorithm based on Thistlethwaite's algorithm, the three-dimensional model to optimally match the one or more constraints with one or more strengths of respective one or more partners and one or more strengths of one or more connections between the respective one or more partners and respective one or more clients.

9. The computer system of claim 8, wherein the computer operation of generate the categorized profile includes the following additional computer operations:
collect, clean, and normalize data about the partners by using principal component analysis and the supervised learning model to select features, wherein the computer operation to clean and normalize the data about the partners provides a consistency and an accuracy in the collected data, and wherein the collected data includes areas of expertise of the partners, past performances of the partners, and client feedback about the partners;
identify, by the supervised learning model, features in the collected, cleaned, and normalized data having a relevancy to the strengths of the partners, the features including knowledge areas of the partners, experience levels of the partners, and a history of relationships involving the partners;
extract the features by using principal component analysis (PCA);
train the supervised learning model by using the identified and extracted features and a k-Nearest Neighbors algorithm; and
validate the trained supervised learning model by using a separate data set to ensure a reliability in predictions by the supervised learning model.

10. The computer system of claim 9, wherein the program instructions cause the processor set to perform the following additional computer operations:
continuously update and refine the collected data and the supervised learning model based on new data about the areas of expertise, the past performances, and the client feedback to maintain an accuracy in a categorization of the partners based on the strengths of the partners.

11. The computer system of claim 8, wherein the program instructions cause the processor set to perform the following additional computer operations:
collect data about the interactions between the partners and the clients, the collected data including a frequency of the interactions, rates of success resulting from the interactions, and scores indicating feedback from the clients and the partners about the interactions;
clean the collected data to remove outliers, manage missing values, and validate relationship metrics included in the collected data, wherein the computer operation of generate the network graph is based on the cleaned data;
estimate, using a graph database model, strengths of the connections between the partners and the clients by measuring weights of the edges in the network graph and using centrality measures, the weights being based on past interactions between the partners and the clients, the strengths of the partners, and measures of trustworthiness of the partners and the clients; and
generate, using the graph database model, a client-partner relationship index based on the estimated strengths of the connections between the partners and the clients.

12. The computer system of claim 11, wherein the program instructions cause the processor set to perform the following additional computer operation:
continuously update the client-partner relationship index and the network graph by using data about new interactions between the partners and the clients to re-estimate the strengths of the connections between the partners and the clients.

13. The computer system of claim 8, wherein the computer operation of generate the three-dimensional matrix of cells includes the following additional computer operations:
define constraints of the project by using the categorized profile of the partners and the network graph, the constraints including a time, a cost, and a scope of the project;
initialize the three-dimensional model as the three-dimensional matrix; and
select a variation of Thistlethwaite's algorithm based on the defined constraints, wherein the computer operation of solve the three-dimensional model uses the selected variation of Thistlethwaite's algorithm.

14. The computer system of claim 8, wherein the program instructions cause the processor set to perform the following additional computer operation:
continuously update the three-dimensional matrix based on data about new projects and alterations in constraints of existing projects.

15. A computer program product comprising:
a set of one or more computer-readable storage media; and
program instructions, collectively stored in the set of one or more computer-readable storage media, for causing a processor set to perform the following computer operations:
generate, using a supervised machine learning model, a categorized profile of partners based on feedback from clients and past performances of the partners, the categorized profile indicating strengths of the partners;
generate a network graph based on data about interactions between the partners and the clients and further based on the categorized profile of the partners, the network graph having nodes representing the partners and the clients and having edges representing connections between the partners and the clients;
generate, using the categorized profile and the network graph, a three-dimensional model represented by a three-dimensional matrix of cells, a given cell representing a part of a project and including one or more constraints of the project; and
solve, using a machine learning algorithm based on Thistlethwaite's algorithm, the three-dimensional model to optimally match the one or more constraints with one or more strengths of respective one or more partners and one or more strengths of one or more connections between the respective one or more partners and respective one or more clients.

16. The computer program product of claim 15, wherein the computer operation of generate the categorized profile includes the following additional computer operations:
collect, clean, and normalize data about the partners by using principal component analysis and the supervised learning model to select features, wherein the computer operation to clean and normalize the data about the partners provides a consistency and an accuracy in the collected data, and wherein the collected data includes areas of expertise of the partners, past performances of the partners, and client feedback about the partners;
identify, by the supervised learning model, features in the collected, cleaned, and normalized data having a relevancy to the strengths of the partners, the features including knowledge areas of the partners, experience levels of the partners, and a history of relationships involving the partners;
extract the features by using principal component analysis (PCA);
train the supervised learning model by using the identified and extracted features and a k-Nearest Neighbors algorithm; and
validate the trained supervised learning model by using a separate data set to ensure a reliability in predictions by the supervised learning model.

17. The computer program product of claim 16, wherein the program instructions cause the processor set to perform the following additional computer operations:
continuously update and refine the collected data and the supervised learning model based on new data about the areas of expertise, the past performances, and the client feedback to maintain an accuracy in a categorization of the partners based on the strengths of the partners.

18. The computer program product of claim 15, wherein the program instructions cause the processor set to perform the following additional computer operations:
collect data about the interactions between the partners and the clients, the collected data including a frequency of the interactions, rates of success resulting from the interactions, and scores indicating feedback from the clients and the partners about the interactions;
clean the collected data to remove outliers, manage missing values, and validate relationship metrics included in the collected data, wherein the computer operation of generate the network graph is based on the cleaned data;
estimate, using a graph database model, strengths of the connections between the partners and the clients by measuring weights of the edges in the network graph and using centrality measures, the weights being based on past interactions between the partners and the clients, the strengths of the partners, and measures of trustworthiness of the partners and the clients; and
generate, using the graph database model, a client-partner relationship index based on the estimated strengths of the connections between the partners and the clients.

19. The computer program product of claim 18, wherein the program instructions cause the processor set to perform the following additional computer operation:
continuously update the client-partner relationship index and the network graph by using data about new interactions between the partners and the clients to re-estimate the strengths of the connections between the partners and the clients.

20. The computer program product of claim 15, wherein the computer operation of generate the three-dimensional matrix of cells includes the following additional computer operations:
define constraints of the project by using the categorized profile of the partners and the network graph, the constraints including a time, a cost, and a scope of the project;
initialize the three-dimensional model as the three-dimensional matrix; and
select a variation of Thistlethwaite's algorithm based on the defined constraints, wherein the computer operation of solve the three-dimensional model uses the selected variation of Thistlethwaite's algorithm.
